(19) United States
(12) Patent Application Publication
(10) Pub. No.: US 2020/0291295 A1
(43) Pub. Date: Sep. 17, 2020

(54) SHELL STRUCTURES FOR COLLOIDAL SEMICONDUCTOR NANOCRYSTALS

(71) Applicant: Lumisyn LLC, Rochester, NY (US)

(72) Inventor: Keith Kahen, Rochester, NY (US)

(73) Assignee: Lumisyn LLC, Rochester, NY (US)

(21) Appl. No.: 16/719,368

(22) Filed: Dec. 18, 2019

Related U.S. Application Data
(60) Provisional application No. 62/782,471, filed on Dec. 20, 2018.

(51) Int. Cl. C09K 11/88; C09K 11/70

(52) U.S. Cl. CPC C09K 11/883; C09K 11/70

(57) ABSTRACT

A nanocrystal has a semiconductor core and a semiconductor shell at least partially surrounding the core. The shell includes at least a first discrete layer of a small-bandgap semiconductor that may be an embedded layer of the shell or provided as a capping layer, or both. The small bandgap semiconductor may include one or more Group IV elements. The shell may include multiple discrete layers. The colloidal semiconductor nanocrystals may have one or more of the following advantages: higher quantum efficiency; improved photoluminescence efficiency at room or elevated temperatures or at high optical excitation flux; improved stability; and improved color purity. In certain embodiments, these performance advantages may be achieved without the need for toxic elements such as arsenic and cadmium.

### CROSS-REFERENCE TO RELATED APPLICATIONS

This application claims priority to U.S. Provisional Patent Application Ser. No. 62/782,471 filed Dec. 20, 2018, which is incorporated by reference herein in its entirety.

### STATEMENT REGARDING FEDERALLY SPONSORED RESEARCH

This invention was made, at least in part, with support from the Department of Energy under Grant No. DE-SC0013249. The government may have certain rights in the invention.

### TECHNICAL FIELD

The present invention relates to shelled colloidal semiconductor nanocrystals having improved emissive and stability properties.

### BACKGROUND

Colloidal semiconductor nanocrystals have many potential uses, for example, as phosphors for solid state lighting and gain material for optically-pumped cw (continuous wave) lasers. For these applications, the operating temperature of the nanocrystals is significantly above room temperature and the optical excitation power density can range from about 10 (in solid state lighting) to greater than 50,000 (for lasing) W/cm². Typical CdSe-based nanocrystals lose significant quantum efficiency under such conditions. Some improvements have been made, but further improvements are needed.

Regarding the spectral width of the nanocrystal emitters, having them be narrow is desirable for display applications (for widening the color gamut) and LED lighting applications (narrow red emitters results in higher efficacies due to less light emitted where the eye response is poor).

Most colloidal semiconductor nanocrystals are sensitive to the ambient environment, e.g., to oxygen and water vapor present in air. Such nanocrystals need to be encased or encapsulated in materials having low oxygen and water permeability. This adds cost to devices using nanocrystals. The encapsulating material may also fail over time. Further improvements are needed to improve the stability of high efficiency nanocrystals exposed to air and moisture.

### SUMMARY

There remains a need for nanocrystals that have high quantum efficiency, high temperature and flux stability, improved air stability and improved color purity.

In accordance with one or more embodiments of this disclosure, a nanocrystal includes a semiconductor core and a semiconductor shell at least partially surrounding the core. The shell includes a first discrete layer of a small-bandgap semiconductor having a bandgap in a range of about 0.2 eV to 1.2 eV and a region, wherein the region comprises a semiconductor having a bandgap of greater than about 1.2 eV.

In accordance with one or more embodiments of this disclosure, a nanocrystal includes a semiconductor core and a semiconductor shell at least partially surrounding the core. The shell includes at least one first discrete layer comprising a Group IV element.

In accordance with various embodiments of this disclosure, a nanocrystal includes a semiconductor core and a semiconductor shell based primarily on II-VI class semiconductors that at least partially coats the core. The shell includes magnesium and at least one Group IV element, wherein the atomic % of the one or more Group IV elements is less than the combined atomic % of all Group II elements of the shell.

The present disclosure provides colloidal semiconductor nanocrystals that may have one or more of the following advantages: high quantum efficiency; improved photoluminescence efficiency at room or elevated temperatures; improved photoluminescence efficiency under high excitation optical flux densities; improved photoluminescence stability; and improved color purity. In certain embodiments, these performance advantages may be achieved without the need for toxic elements such as arsenic and cadmium.

### BRIEF DESCRIPTION OF THE DRAWINGS

The following detailed description of specific embodiments of the present disclosure can be best understood when read in conjunction with the following drawings, in which:

FIGS. 1A, 1B, 1C and 2 are cross-sectional views of colloidal semiconductor nanocrystals according to various embodiments of the present disclosure;

FIG. 3 is a graph showing the photoluminescent intensity in arbitrary units as a function of time for an embodiment of the nanocrystals of the present disclosure; and

FIG. 4 is a spectral graph showing the photoluminescent intensity in arbitrary units as a function of wavelength and irradiation time for an embodiment of the nanocrystals of the present disclosure.

### DETAILED DESCRIPTION

As used throughout this disclosure, “electrons and holes” may refer to “excitons” and/or unbound electrons and holes. Reference to Group II, III, IV, V and VI elements is made following the Chemical Abstracts Services (CAS) naming protocol of the periodic table of elements. Unless otherwise specified, Group II herein refers to both IIA and IIB (Group Numbers 2 and 12 of the modern IUPAC system), Group III refers specifically to IIIA (Group Number 13 of the modern IUPAC system), Group IV refers specifically to IVA (Group Number 14 of the modern IUPAC system), Group V refers specifically to VA (Group Number 15 of the modern IUPAC system) and Group VI refers specifically to VIA (Group Number 16 of the modern IUPAC system).

As used throughout this disclosure, the nanocrystals may be referred to as “colloidal” meaning that they form a colloidal solution in which the nanocrystals do not settle at the bottom of the solution, but remain in a generally suspended state, in which the crystals are at least partially dispersed in the solution. In contrast, conventional nanocrystals, such as those formed by classical semiconductor growth processes, (including molecular beam epitaxy (MBE) or metal-organic chemical vapor deposition (MOCVD)) the nanocrystals are typically called self-assembled quantum dots.

Embodiments of the present disclosure may have one or more of the following features: high quantum efficiencies at room temperature; high quantum efficiencies at elevated temperatures, e.g., at 170° C. or even higher; high quantum efficiencies at very high optical flux densities, e.g., at 5 kW/cm² or even higher; improved stability at room temperature; improved stability at elevated temperatures; improved stability at very high optical flux densities; improved stability in air; improved color purity at room temperature; improved color purity at elevated temperatures; and improved color purity at very high optical flux densities. Given these properties, the nanocrystals may be used as advantaged phosphors in solid state lighting, display, and LED applications to produce high quality light having higher efficiency than conventional nanocrystals. Moreover, optically-pumped devices containing nanocrystals of the present disclosure can also be formed. Some examples are optically-pumped cw-ASE (amplified spontaneous emission) devices and optically-pumped lasers. The cw-ASE device produces highly-polarized, spectrally-narrow, and spatially-coherent light. As an example, a cw-ASE device can be used to make advantaged LCD displays when employed as a backlight. The applications of optically-pumped lasers are myriad, including, for example, medical, biological, and semiconductor-based applications. In addition to their stable quantum efficiencies, the nanocrystals of the present disclosure have non-blinking characteristics in such applications as single photon emitters (for quantum computing) and for biological tracking.

Embodiments of the present disclosure provide colloidal, enhanced-confinement semiconductor nanocrystals. An “enhanced-confinement” nanocrystal refers to the enhancement of the confinement of the electrons and holes to a center area of the nanocrystal, for which the radius of the area is much smaller than the exciton Bohr radius.

As used throughout this disclosure, the prefix “nano” (such as nanocrystal) refers to a component having an average size, such as an average length, width, or diameter, of from 0.1 to 100 nm.

Specific embodiments will now be described with reference to the figures. Whenever possible, the same reference numerals will be used throughout the drawings to refer to the same or like parts. As used throughout this disclosure, the singular forms “a,” “an” and “the” include plural referents unless the context clearly dictates otherwise. Thus, for example, reference to “a” component includes aspects having two or more such components, unless the context clearly indicates otherwise.

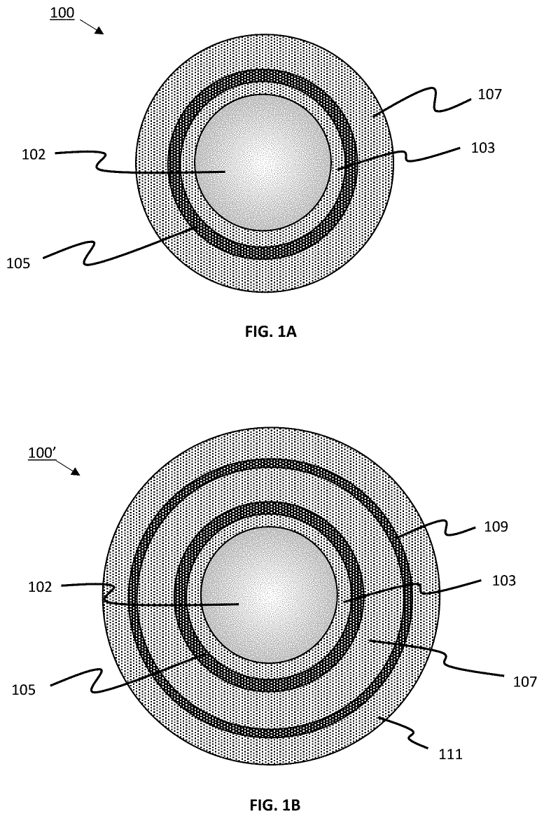

Embodiments of the present disclosure include a nanocrystal that include a semiconductor core and a semiconductor shell at least partially surrounding the core, the shell comprises a first discrete layer of a small-bandgap semiconductor having a bandgap in a range of about 0.2 eV to about 1.2 eV. The shell also includes a region comprising a semiconductor having a bandgap of greater than about 1.2 eV. In some embodiments, the shell includes multiple regions. In one or more embodiments, the region may include a first region, a second region, and a third region. In some embodiments, the shell includes one discrete layer or multiple discrete layers. In one or more embodiments, the shell includes the first discrete layer, a second discrete layer, a third discrete layer, and a fourth discrete layer. One or more embodiments of the colloidal semiconductor nanocrystal of the present disclosure is schematically illustrated in FIG. 1A. In FIG. 1A, nanocrystal 100 has a semiconductor core 102. A semiconductor shell is provided over the core, the shell including a first region 103 adjacent to the core, a first discrete layer 105 of a small-bandgap semiconductor provided over the first region, and a second region 107 provided over the first discrete layer 105. In an alternative embodiment (not illustrated), the first region 103 is absent and the first discrete layer 105 is adjacent to core 102. In some embodiments, the discrete layer may be in the embedded layer. The term “embedded layer” refers to any layer of the shell between the core and the capping layer. As discussed below with respect to FIG. 1C, the discrete layer may be a capping layer. The term “capping layer” means the outermost layer of the shell. FIG. 1 depicts a non-limiting illustration of the nanocrystal as spherical. In various embodiments, the colloidal nanocrystal may be oblong, faceted or other shapes, such as those shapes common to colloidal nanocrystals. In one or more embodiments, the total shell thickness may be up to 100 monolayers. In some embodiments, the radius of the semiconductor core in the largest dimension is in a range of 1 nm to 15 nm, for example, in a range of 1 nm to 5 nm.

In various embodiments, the discrete layer includes a small bandgap semiconductor having a bandgap in a range of about 0.2 eV to about 1.2 eV, about 0.5 eV to 1.2 eV, or 0.2 eV to 0.8 eV. In some embodiments, the discrete layer includes at least one Group IV element. The Group IV element of the discrete layer may be Si, Ge, Sn or Pb, or a combination thereof. In an embodiment, the Group IV element of the discrete layer is Si or Ge, or a combination thereof. In an embodiment, the discrete layer includes at least one half (½) of a monolayer of one or more Group IV element(s). In an embodiment, the discrete layer includes at least one (1) monolayer of one or more Group IV elements. In an embodiment, the number of monolayers of the Group IV element(s) of the discrete layer may be in a range from about one half (½) up to about ten (10), alternatively up to about five (5), alternatively up to two (2) In an embodiment, the discrete layer includes one-half (½) or one (1) monolayer of the Group IV element(s). When more than one Group IV element is used, the discrete layer may include a uniform distribution of the elements, a gradient distribution of the elements, any non-uniform functional variation of the elements, or separate, individual half-monolayers of each element. Each discrete layer does not include small bandgap semiconductors or group IV elements that are merely provided as dopants distributed within the shell.

In some embodiments, the discrete layer may include an indirect semiconductor. As a result of the material being indirect, the absorption of the nanocrystal's excitation and emission light is reduced by orders of magnitude compared to the case where small bandgap semiconductor is a direct semiconductor. By highly reducing this unwanted absorption, the quantum efficiency of the nanocrystal does not get negatively impacted. Column IV materials, such as, Si and Ge, are some non-limiting examples of indirect semiconductors, thus being aligned with these considerations.

In some embodiments, semiconductor core 102 may include III-V class semiconductors, II-VI class semiconductors, IV class semiconductors, IV-VI class semiconductors, I—III-VI class semiconductors, or I-IV-VII class semiconductors. Some non-limiting examples of semiconductor materials that may be used in the core, alone or in combination, include InP, InGaP, InN, InPN, InPSb, InAlP, GaN, GaP, InAs, InSb, GaAs, GaSb, AlAs, AlSb, InAsSb, GaAsSb, AlAsSb, InAlP, InAlSb, InAlAs, CdSe, CdZnSe, ZnSe, CdTe, CdZnSTe, Ge, Si, GeSi, CuInS, and CsPbBr. It will be appreciated by those skilled in the art that the preceding chemical formulae may not necessarily represent a particular stoichiometry, but rather, the formulae are intended to convey the presence of a particular set of materials. For example, one of ordinary skill in the art would understand that InGaP generally refers to any composition represented by InₓGa₍₁₋ₓ₎P, in which X is greater than 0 and less than 1 (0<X<1). In some embodiments, the elemental composition of the core may be homogeneous. In some embodiments, the elemental composition of the core is non-homogeneous and varies along at least a portion of the core radius. In some embodiments, the core may include inner and outer regions having different elemental compositions or distributions of components, wherein one or both of the regions may have a non-homogeneous distribution of components. For the case of typical enhanced-confinement ternary III-V or II-VI class semiconductor nanocrystals, the diameter of the non-homogeneous inner core region may be less than 2.0 nm, such as from 0.5 to 1.5 nm, and the thickness of the outer core region may be in the range of about 0.5 to 4 nm, such as from about 0.75 to 2.0 nm.

In some embodiments, aside from the discrete layer discussed above, the semiconductor shell may include III-V class semiconductors, II-VI class semiconductors, I—III-VI class semiconductors, and I-IV-VII class semiconductors. The shell material composition adjacent to the core is typically different from the underlying core, although it may contain some of the same elements. The composition of first region 103 may be the same as or different from second region 107. Some non-limiting examples of semiconductor materials that may be used in the shell, alone or in combination, include InP, InGaP, InN, InPN, InPSb, InAlP, GaN, GaP, InAs, InSb, GaAs, GaSb, AlAs, AlSb, InAsSb, GaAsSb, AlAsSb, InAlP, InAlSb, InAlAs, CdSe, CdZnSe, ZnSe, CdTe, CdZnSTe, ZnSe, ZnS, ZnSeS, CdSe, CdS, CdSeS ZnMgSe, ZnMgS, ZnMgSeS, CdMgSe, CdMgS, or CdMgSeS, CuInS, and CuCl. It will be appreciated by those skilled in the art that the preceding chemical formulae may not necessarily represent a particular stoichiometry, but rather, the formulae are intended to convey the presence of a particular set of materials.

In various embodiments, not including the discrete layer, the semiconductor shell includes 50 atomic percent (atomic %) to 100 atomic % of a II-VI class semiconductor materials. In some embodiments the semiconductor shell comprises at least 95 atomic % of a II-VI class semiconductor materials. In an embodiment, the II-VI class shell includes Zn, Mg or Cd, or a combination thereof as the Group II element(s). In an embodiment the II-VI class shell further includes S, Se or Te, or a combination thereof as the Group VI element(s). The II-VI class semiconductor shell may include multiple regions of differing compositions, a compositional gradient or both. The II-VI class semiconductor shell may include one or more regions of binary, ternary, quaternary or higher semiconductor structures, or a combination thereof. In an embodiment, the II-VI class semiconductor shell does not include cadmium. In an embodiment, the shell includes one or more of ZnS, ZnSe, ZnTe, ZnSSe, ZnSTe, ZnSeTe, ZnSSeTe, MgS, MgSe, MgTe, MgSSe, MgSTe, MgSeTe, MgSSeTe, ZnMgS, ZnMgSe, ZnMgTe, ZnMgSSe, ZnMgSTe, ZnMgSeTe, or ZnMgSSeTe. It will be appreciated by those skilled in the art that the preceding chemical formulae may not necessarily represent a particular stoichiometry, but rather, the formulae are intended to convey the presence of a particular set of materials. In an embodiment, the shell layer provided immediately over the core includes ZnSe.

In another embodiment illustrated in FIG. 1B, nanocrystal 100′ is as described above for FIG. 1A, but the shell includes a second discrete layer 109 of a small-bandgap semiconductor provided over second region 107 and a third region 111 provided over the second discrete layer 109. The second discrete layer thickness and composition may be the same as or different from discrete layer 105. The composition of third region 111 may be the same as or different from the first or second regions. Not shown, the nanocrystal shell may include additional discrete layers. In some embodiments, the nanocrystal may include up to 50 discrete layers, alternatively up to 10 discrete layers.

In another embodiment illustrated in FIG. 1C, the shell of nanocrystal 100″ includes a discrete layer 113 of a small-bandgap semiconductor provided at the outer edge of the nanocrystal shell as a capping layer. The materials, distribution and thickness of discrete layer 113 may be the same as or different from first discrete layer 105. First discrete layer 105, second discrete layer 109, and discrete layer 113 may alternatively be used alone as the sole discrete layer of the shell.

It has been found that nanocrystals incorporating one or more discrete layers in the shell may produce significant improvements in quantum efficiency, stability, and/or color purity. In certain embodiments, the discrete layer(s) may optionally be incorporated into colloidal, enhanced-confinement semiconductor nanocrystals having a II-VI class semiconductor shell, at least a portion of which includes magnesium.

Embodiments of a Mg-containing colloidal semiconductor nanocrystal are schematically illustrated in FIG. 2. For clarity, discrete layer(s) of a Group IV element(s) are not shown, but their placement is discussed later. In FIG. 2, nanocrystal 200 has a semiconductor core 202. A II-VI class semiconductor shell is provided over the core, the shell including a magnesium-containing first zone 206 and a second zone 208 having less magnesium than the first zone. The shell further includes a buffer zone 204 provided between the core and the first zone. In an alternative embodiment, the nanocrystal may include second zone 208 but not buffer zone 204. In an alternative embodiment, the nanocrystal may include buffer zone 204, but not second zone 208.

One or more discrete layers each having a small bandgap semiconductor, for example, one or more Group IV elements, may be an embedded layer anywhere within the shell structure of FIG. 2 or as a capping layer. For example, one or more discrete layers as described previously may be provided: adjacent the core, within buffer zone 204, between buffer zone 204 and first zone 206, within first zone 206, between first zone 206 and second zone 208, within second zone 208, or over second zone 208.

While FIG. 2 depicts the nanocrystal as spherical, it is nonetheless intended that the colloidal nanocrystal is not necessarily spherical, but may be oblong, faceted or other shapes, such as those shapes common to colloidal nanocrystals. In some embodiments, the total shell thickness may be up to 100 monolayers. In some embodiments, the radius of the semiconductor core in the largest dimension is typically in a range of 1 nm to 15 nm, for example, in a range of 1 nm to 5 nm.

Semiconductor core 202 may be as described previously for core 102. The shell's magnesium-containing first zone 206 includes at least some magnesium as one of the group II elements and may further include another group II element such as Zn, Be, Cd, Hg, or a combination thereof. The corresponding group VI element may, for example, be S, Se, Te or a combination thereof. The magnesium-containing first zone may be homogeneous or non-homogeneous with respect to chemical composition throughout the zone. In some embodiments, the magnesium-containing first zone may include ZnMgSe, ZnMgS, ZnMgSeS, CdMgSe, CdMgS, CdMgSeS or a combination thereof. As mentioned before, it will be appreciated by those skilled in the art that the preceding chemical formulae may not necessarily represent a particular stoichiometry, but rather, the formulae are intended to convey the presence of a particular set of materials. In some embodiments the atomic ratio of magnesium to all other group II elements (e.g., Zn or Cd) in the magnesium-containing first zone may be in a range from about 4:1 to about 1:10, alternatively in a range from about 3:1 to about 1:5. In some embodiments, the first zone is in a range of about 1 to 8 monolayers thick.

The shell's second zone may include a II-VI class semiconductor material. In some embodiments, the second zone may include magnesium as one of the group II elements, but if so, the atomic % of magnesium in the second zone is lower than the atomic % of magnesium in the magnesium-containing first zone. In some embodiments, the second zone is substantially free of magnesium. The group II element in the second zone may, for example, include Zn, Mg, Be, Cd, Hg, or a combination thereof. The corresponding group VI element in the second zone may, for example, include S, Se, Te or a combination thereof. The second zone may be homogeneous or non-homogeneous with respect to chemical composition throughout the zone. In some embodiments, the second zone may include ZnSe, ZnS or ZnSeS or a combination thereof. As mentioned previously, it will be appreciated by those skilled in the art that the preceding chemical formulae may not necessarily represent a particular stoichiometry, but rather, the formulae are intended to convey the presence of a particular set of materials. In some embodiments, the second zone is in a range of about 4 to 20 monolayers thick.

In some embodiments, the shell may include a buffer zone that may include a II-VI class semiconductor material having a lower atomic % of magnesium than the first zone. In some embodiments, the buffer zone may be substantially free of magnesium. The group II element in the buffer zone may, for example, include Zn, Cd, Hg, or a combination thereof. The corresponding group VI element in the buffer zone may, for example, be S, Se, Te or a combination thereof. The buffer zone may be homogeneous or non-homogeneous with respect to chemical composition throughout the zone. In some embodiments, the buffer zone may include ZnSe, ZnS, ZnSeS, CdSe, CdS, CdSeS or a combination thereof. As mentioned previously, it will be appreciated by those skilled in the art that the preceding chemical formulae may not necessarily represent a particular stoichiometry, but rather, the formulae are intended to convey the presence of a particular set of materials. In some embodiments, the buffer zone is thinner than the first or second zones. In some embodiments, the buffer zone is in a range of about 1 to 4 monolayers thick. In some embodiments, the buffer zone may include a monolayer of ZnSe.

A number of standard processes known in the art can be followed for creating the colloidal semiconductor nanocrystal. In general, they may involve combining cation and anion precursors in appropriate solvents. The nanocrystal composition may be controlled by adjusting the ratios of precursors, the sequence of addition, reaction time, reaction temperature and other factors known in the art.

In accordance with an aspect of the present disclosure, the cation precursor used for synthesizing the nanocrystal of the present disclosure may be a group II, III, or IV material. Some non-limiting examples of group II cation precursors are Cd(Me)₂, CdO, CdCO₃, Cd(Ac)₂, CdCl₂, Cd(NO₃)₂, CdSO₄, Cd oleate, Cd stearate, ZnO, ZnCO₃, Zn(Ac)₂, Zn(Et)₂, Zn stearate, Zn oleate, MgO, Mg stearate, Mg oleate, Hg₂O, HgCO₃ and Hg(Ac)₂. Some non-limiting examples of group III cation precursors are In(Ac)₃, InCl₃, In(acac)₃, In(Me)₃, In₂O₃, Ga(acac)₃, GaCl₃, Ga(Et)₃, and Ga(Me)₃. Some non-limiting examples of group IV cation precursors include alkyl-silane, alkyl-germane, alkyl-tin, and acetylacetonate-lead compounds to name just a few. Other appropriate cation precursors well known in the art can also be used.

In some embodiments, the anion precursor used for the synthesis of the nanocrystal may be a material selected from a group consisting of S, Se, Te, N, P, As, and Sb (when the semiconducting material may be a II-VI, III-V, or IV-VI compound). Some examples of corresponding anion precursors are bis(trimethylsilyl)sulfide, tri-n-alkylphosphine sulfide, aminosulfide, hydrogen sulfide, tri-n-alkylphosphine selenide, aminoselenide, tri-n-alkylphosphine telluride, aminotelluride, bis(trimethylsilyl)telluride, tris(trimethylsilyl)phosphine, triethylphosphite, sodium phosphide, potassium phosphide, trimethylphosphine, tris(dimethylamino)phosphine, tricyclopentylphosphine, tricyclohexylphosphine, triallylphosphine, di-2-norbornylphosphine, dicyclopentylphosphine, dicyclohexylphosphine, dibutylphosphine, tris(trimethylsilyl)arsenide, sodium arsenide, and potassium arsenide. Other appropriate anion precursors known in the art can also be used.

Many high boiling point compounds exist that may be used both as reaction media (coordinating solvents) and, more importantly, as coordination (growth) ligands to stabilize the metal ion after it is formed from its precursor at high temperatures. These may also aid in controlling particle growth and impart colloidal properties to the nanocrystals. Among the different types of coordination ligands that can be used, some common ones are alkyl phosphine, alkyl phosphine oxide, alkyl phosphate, alkyl amine, alkyl phosphonic acid, and fatty acids. The alkyl chain of the coordination ligand is typically a hydrocarbon chain of length greater than 4 carbon atoms and less than 30 carbon atoms, which can be saturated, unsaturated, or oligomeric in nature. It may also have aromatic groups in its structure.

Specific examples of suitable coordination (growth) ligands and ligand mixtures include, but are not limited to, trioctylphosphine, tributylphosphine, tri(dodecyl)phosphine, trioctylphosphine oxide, tributylphosphate, trioctyldecyl phosphate, trilauryl phosphate, tris(tridecyl)phosphate, triisodecyl phosphate, bis(2-ethylhexyl)phosphate, hexadecylamine, oleylamine, octadecylamine, bis(2-ethylhexyl)amine, octylamine, dioctylamine, cyclododecylamine, N,N-dimethyltetradecylamine, N,N-dimethyldodecylamine, phenylphosphonic acid, hexyl phosphonic acid, tetradecyl phosphonic acid, octylphosphonic acid, octadecyl phosphonic acid, propylphosphonic acid, aminohexyl phosphonic acid, oleic acid, stearic acid, myristic acid, palmitic acid, lauric acid, and decanoic acid. Further, they can be used by diluting the coordinating ligand with at least one solvent selected from a group consisting of, for example, 1-nonadecene, 1-octadecene, cis-2-methyl-7-octadecene, 1-heptadecene, 1-pentadecene, 1-tetradecenedioctylether, dodecyl ether, and hexadecyl ether, or the like.

In some embodiments to form nanocrystals comprising III-V materials, the growth ligands may include column II metals, such as Zn, Cd or Mg. In some particular embodiments, the zinc compound is zinc carboxylate having the formula:

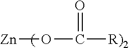

in which R is a hydrocarbon chain of length equal to or greater than 1 carbon atom and less than 30 carbon atoms, which are saturated, unsaturated, or oligomeric in nature. It may have aromatic groups in its structure. Specific examples of suitable zinc compounds include, but are not limited to, zinc acetate, zinc undecylenate, zinc stearate, zinc myristate, zinc laurate, zinc oleate, zinc palmitate, or combinations thereof.

Examples of non-coordinating or weakly coordinating solvents include higher homologues of both saturated and unsaturated hydrocarbons. Mixture of two or more solvents can also be used. In some embodiments, the solvent may be selected from unsaturated high boiling point hydrocarbons, CH₃(CH₂)ₙCH═CH₂ wherein n=7-30, such as, 1-nonadecene, 1-octadecene, 1-heptadecene, 1-pentadecene, or 1-eicosene, where the specific solvent used may be based on the reaction temperature of the nanocrystal synthesis.

The solvents used in accordance with the present disclosure may be coordinating or non-coordinating, a list of possible candidates being given above. The solvent may have a boiling point above that of the growth temperature; as such, prototypical coordinating and non-coordinating solvents are trioctylphosphine and octadecene, respectively. However, in some cases, lower boiling solvents are used as carriers for the precursors; for example, tris(trimethylsilyl)phosphine can be mixed with hexane in order to enable accurate injections of small amounts of the precursor.

When forming II-VI class shells, the shelling temperatures may typically be in a range of about 150° C. to about 300° C. In order to avoid the formation of nanocrystals composed solely of the shelling material, the shell precursors can be slowly dripped together from separately prepared solutions or the shell precursors are added one-half monolayer at a time (again typically at a slow rate). When using II-VI materials to shell III-V based nanocrystal cores, the surfaces of the nanocrystals may be etched in weak acids [E. Ryu et al., Chem. Mater. 21, 573 (2009)] and then annealed at elevated temperatures (e.g., from 180° C. to 260° C.) prior to shelling. One example of a weak acid is acetic acid. As a result of the acid addition and annealing, the nanocrystals tend to aggregate. In some embodiments, ligands may be added to the growth solution prior to the initiation of the shelling procedure. Useful ligands include primary amines, such as, hexadecylamine, or acid-based amines, such as, oleylamine. As is well-known in the art, it may be also beneficial to anneal the nanocrystals near or above the shelling temperatures following each shelling step for times ranging from 10 to 240 minutes.

One or more embodiments of the disclosure includes a layer. In embodiments, the layer includes a matrix material and nanocrystals according to any of the embodiments of the nanocrystals of this disclosure dispersed therein. In some embodiments, the matrix comprises a silicone, a polymer or a glass.

Embodiments of this disclosure include a solid-state lighting or display device comprising the layer as described in this disclosure.

### EXAMPLES

The following examples are presented as further understandings of the present disclosure and are not to be construed as limitations thereon. Methods of making nanocrystals are well known to the skilled artisan, but a synthetic preparation is described for Example 1 for illustrative purposes. Similar methods and materials were used to prepare other examples and comparisons.

The present examples and comparisons generally include a non-homogeneous InGaP core that is shelled with predominantly II-VI class semiconductors.

### Example 1

Example 1 had a structure that can be described in shorthand as follows where forward slashes denote a new layer, subscripts denote approximate atomic stoichiometry if other than 1, and parentheticals refer to the number of monolayers:
Core/ZnSe/Zn_{0.55}Mg_{0.45}Se_{0.20}S_{0.80}(3)/ZnSe_{0.75}S_{0.25}(1)/Zn(1/2)Si(1/2).

InGaP core nanocrystals were prepared as follows. A flask was filled with 9 ml of octadecene (ODE), 45 mg of Zn undecylenate and 120 mg of myristic acid. The mixture was degassed at 100° C. for 1.5 hours. After switching to N₂ overpressure, the flask contents were heated to 300° C., while vigorously stirring its contents. Three precursor solutions were prepared and loaded into corresponding syringes. The first precursor solution contained 7.8 mg trimethylindium (TMIn), 5.9 μl of tris(trimethylsilyl)phosphine (P(TMS)3), 15.8 μl of oleylamine, 69 μl of hexane and 1.4 ml ODE; the second precursor solution contained 5 μl of triethylgallium (TEGa), 5.9 μl of tris(trimethylsilyl)phosphine (P(TMS)3), 9.4 μl of oleylamine, 113 μl of hexane and 1.39 ml of ODE; and the third precursor solution contained 15.5 μl of triethylgallium (TEGa), 26.3 μl of oleylamine, 140 μl of hexane and 2.44 ml of ODE. When the reaction flask reached 300° C., the first and second syringes were simultaneously injected quickly by hand into the hot flask to form a non-homogeneous inner core of InGaP. After a time delay of about 1-2 s, the third syringe was rapidly injected into the hot flask by hand to form a non-homogeneous outer-core region of InGaP. After the third injection, the flask temperature was lowered to about 270° C. and the nanocrystals were grown for 10-60 minutes in total. The reaction was stopped by removing the heating source.

The InGaP core nanocrystals were shelled with wider bandgap II-VI materials. The shelling began with a weak acid etch of the nanocrystals. After the reaction flask was cooled to room temperature under continuous stirring, 200 μl acetic acid was loaded into a syringe and then injected into the flask. This was followed by annealing the contents of the flask for 60 minutes at 190° C. Since the nanocrystals aggregated following this step, 0.5 ml of oleylamine was injected into the flask. The contents were then annealed at 190° C. for 10 minutes.

ZnSe/ZnMgSeS/ZnSeS/Zn(1/2)/Si(1/2) shells were grown on the etched nanocrystals at 190° C. by the following procedure. The precursor solutions containing Zn, Mg, Si, Se, and S were prepared in a glovebox prior to growing the shells. The first solution of 315 μl of diethylzinc (DEZ) solution (1 M DEZ in hexane) and 1.5 ml of ODE was added dropwise to the reaction mixture under vigorous stirring; the flask contents were then annealed at 190° C. for 15 minutes to form approximately one-half monolayer of Zn. A second solution of 28 mg of Se powder, 200 μl of tri-n-butylphosphine, and 1.5 ml of ODE was then added dropwise to the reaction mixture under vigorous stirring; the flask contents were then annealed at 190° C. for 15 minutes to form approximately one-half monolayer of Se. For the ZnMgSeS shells, the Zn and Mg precursors were stearate-based. For example, the Zn stearate solution was formed by combining 2.5 g of Zn stearate powder, 12 ml of ODE, 2.5 ml of tri-n-octylphosphine, and 2.5 ml of oleylamine. The stearate solution turns clear when vigorously stirring at 150 C. For the second shell, the syringe solution contained 1.11 ml of Zn(St)₂ solution, 905 μl of Mg(St)₂ solution, and 0.2 ml of oleylamine. The solution was added dropwise to the reaction mixture under vigorous stirring; the flask contents were then annealed at 190° C. for 15 minutes to form approximately one-half monolayer of ZnMg. A second solution of 7.3 mg of Se powder, 11.9 mg of S powder, 200 μl of tri-n-butylphosphine, and 1.3 ml of ODE was then added dropwise to the reaction mixture under vigorous stirring; the flask contents were then annealed at 190° C. for 15 minutes to form approximately one-half monolayer of SeS. Subsequent ZnMgSeS, ZnSeS, and Zn shells were added in a similar fashion. To form the one-half monolayer of Si, the precursor solution contained 1.2 ml of ODE and 149 ul of butyltrichlorosilane. The solution was added dropwise to the reaction mixture under vigorous stirring; the flask contents were then annealed at 190° C. for 15 minutes to form approximately one-half monolayer of Si.

Relative quantum yield measurements were performed on the nanocrystals by procedures well-known in the art. The comparison fluorescent material was Rhodamine 6G, which has an absolute quantum efficiency of 95%. The crude nanocrystal suspensions were washed using procedures well-known in the art and the washed nanocrystals were mixed with toluene to make the quantum yield measurements. Example 1 nanocrystals were found to have a photoluminescence peak wavelength (PL peak) at 576.7 nm with a quantum efficiency (QE) of 89% and a spectral width of 56.1 nm.

### Comparison 1

Comparison 1 nanocrystals had the following structure:
Core/ZnSe/Zn_{0.55}Mg_{0.45}Se_{0.20}S_{0.80}(3)/ZnSe_{0.75}S_{0.25}(1)
   Comparison 1 was similar to Example 1 but without the last layer, i.e., it did not include any discrete layer. Comparison 1 nanocrystals were found to have a PL peak at 577.6 nm with a QE of 62%, substantially lower than Example 1, and a spectral width of 59.1 nm, broader than Example 1. Thus, nanocrystals having a shell which includes a Group IV element provided as a discrete layer (in the case of Example 1, as an outermost or capping layer) results in substantially improved QE and color purity (reduced spectral width) relative to a nanocrystal without the discrete layer.

### Example 2

Example 2 nanocrystals had the following structure:
Core/ZnSe/Zn_{0.55}Mg_{0.45}Se_{0.20}S_{0.80}(3)/Zn(1/2)Si(1/2)/ZnSe_{0.75}S_{0.25}(1).
   Example 2 nanocrystals were found to have a PL peak at 577 nm with a QE of 79% and a spectral width of 59.9 nm.

### Comparison 2

Comparison 2 nanocrystals had the following structure:
Core/ZnSe/Zn_{0.55}Mg_{0.45}Se_{0.20}S_{0.80}(3)
   Comparison 2 was similar to Example 2 but without the last two layers, i.e., it did not include any discrete layer. Comparison 2 nanocrystals were found to have a PL peak at 580 nm with a QE of 52%, substantially lower than Example 2, and a spectral width of 67.1 nm, broader than Example 2. Thus, nanocrystals having a shell which includes a Group IV element provided as a discrete layer (in the case of Example 2, as an embedded layer) results in substantially improved QE and color purity relative to nanocrystals without the discrete layer.

### Example 3

Example 3 nanocrystals had the following structure:
Core/ZnSe/ZnSe_{0.50}S_{0.50}(11)/Zn(1/2)Si(1/2)/ZnSe_{0.50}S_{0.50}(1)/Si(1)/ZnSe_{0.50}S_{0.50} (1)/Si(1)/ZnSe_{0.50}S_{0.50}(1)/Si(1) Example 3 nanocrystals were found to have a PL peak at 566.6 nm with a QE of 77% and a spectral width of 65.5 nm.

### Comparison 3

Comparison 3 nanocrystals had the following structure:
Core/ZnSe/ZnSe_{0.50}S_{0.50}(11)
   Comparison 3 was similar to Example 3 but with only the first two shell layers, i.e., it did not include any discrete layer. Comparison 3 nanocrystals were found to have a PL peak at 570.2 nm with a QE of 71%, lower than Example 3, and a spectral width of 70.7 nm, broader than Example 2. Thus, nanocrystals having a shell which includes a Group IV element provided as a discrete layer (in the case of Example 3, as multiple embedded layers and as a capping layer) results in substantially improved QE and color purity relative to nanocrystals without any discrete layer. Typically, adding a large amount of shell material at such a high monolayer level would result in significant QE fall-off and spectral broadening. The presence of Group IV elements provided as one or more discrete layers enables much thicker shells to be formed without sacrificing optical performance. In some embodiments, thicker shells may result in better long-term stability, improved processing and increased environmental robustness.

### Examples 4-9

Examples 4-9 all start with a similar base structure, Base Structure 1, which includes an embedded discrete layer. Base Structure 1 has the following structure:
Core/ZnSe(1)/ZnMgSeS(3)/ZnSeS(4)/Zn(1/2)Si(1/2)/ZnSeS(1)
   Examples 4-9 show the utility of nanocrystals having additional discrete layers.

### Example 4

Example 4A. A base structure similar to that described above for Base Structure 1 was prepared and found to have a photoluminescence peak wavelength (PL peak) at 601.2 nm with a quantum efficiency (QE) of 69% and a spectral width of 82.3 nm.

Example 4B. Over the base structure of Example 4A, two (2) monolayers of ZnSeS were added but the QE dropped to 65% and the spectral width broadened to 83.8 nm (PL peak at 601.1 nm). Addition of further ZnSeS monolayers further suppresses the QE and broadens the spectral width due to the creation of defects.

Example 4C. Over base structure of Example 4A the following layers were added:
ZnSeS(2)/Zn(1/2)Si(1/2)/ZnSeS(1)/Si(1).

Example 4C nanocrystals had a PL peak of 602 nm and a QE of 81%, a significant boost over both Example 4A and Example 4B. The spectral width was 82.4 nm, similar to Example 4A and a significant improvement over Example 4B. Thus, the addition of Si to the shell as a second discrete layer embedded in combination with a third discrete layer provided as a capping layer produces additional QE advantages over Example 4A and Example 4B, and further allows the preparation of high performance nanocrystals having thicker shells if so desired. In some embodiments, thicker shells can result in better long-term stability, improved processing and increased environmental robustness.

### Example 5

Example 5A. A base structure was prepared like Example 4A but having a slightly different InGaP core. Example 5A nanocrystals were found to have a PL peak at 575.3 nm with a QE of 68% and a spectral width of 65.5 nm.

Example 5B. Over the base structure of Example 5A, two (2) monolayers of ZnSeS were added but the QE of these nanocrystals dropped to 58%. Example 5B nanocrystals had a PL peak at 577.8 nm and a spectral width of 66.2 nm.

Example 5C. Over base structure of Example 5A the following layers were added:
ZnSeS(2)/Si(1)/ZnSeS(1)/Si(1)/ZnSeS(1)/Si(1)/ZnSeS(1)/Si(1).
   Example 5C nanocrystals had a PL QE of 72%, a significant boost over both Example 5A and Example 5B. Further, the PL peak was 572.3 and the spectral width was only 58.2 nm, much narrower than Example 5B. Thus, the addition of Si embedded as second, third and fourth discrete layers in the shell, in combination with a fifth discrete layer provided as a capping layer produces additional QE advantages over Example 5A and Example 5B, and further allows the preparation of high performance nanocrystals having thicker shells if so desired. The discrete layer(s) reduces the spectral width which is desired for high color purity applications.

### Example 6

Example 6A. A base structure was prepared like Example 4A but having a slightly different InGaP core. Example 6A nanocrystals were found to have a PL peak at 565.2 nm with a 65.3 nm spectral width.

Example 6B. Over base structure of Example 6A the following layers were added:

SiGe(1)/ZnSeS(1)/SiGe(1), where for the SiGe layers, the molar ratios were 1:1. Example 6B nanocrystals were found to have a PL peak at 563.6 and a spectral width of 57.3 nm, much narrower than Example 6A. Thus, the addition of SiGe embedded as a second discrete layer in the shell in combination with a SiGe capping layer (third discrete layer) produces additional spectral property advantages over Example 6A and further allows the preparation of high performance nanocrystals having thicker shells if so desired. The discrete layer reduces the spectral width which is desired for high color purity applications.

### Example 7

Example 7A. A base structure was prepared like Example 4A but having a slightly different InGaP core. Example 7A nanocrystals were found to have a PL peak at 564.6 nm with a 64.8 nm spectral width.

Example 7B: Over the base structure of Example 7A, two (2) monolayers of ZnSeS were added. Example 7B nanocrystals were found to have a PL peak at 567.3 nm and a spectral width of 65.5 nm, broader than Example 7A.

Example 7C: Over base structure of Example 7A the following layers were added:
ZnSeS(2)/Zn(1/2)/Si(1/2)/ZnSeS(1)/Si(1)/ZnSeS(1)/Si(1)/ZnSeS(1)/Si(1)/ZnSeS(1)/Si(1).

Example 7C nanocrystals were found to have a PL peak at 562.0 and a spectral width of 56.0 nm, much narrower than Examples 7A or 7B. Thus, the addition of Si embedded as second, third, and fourth discrete layers in the shell in combination with a Si capping layer (fifth discrete layer) produces additional spectral property advantages over Example 7A and 7B, and further allows the preparation of high performance nanocrystals having thicker shells if so desired. The discrete layer(s) reduces the spectral width which is desired for high color purity applications.

### Example 8

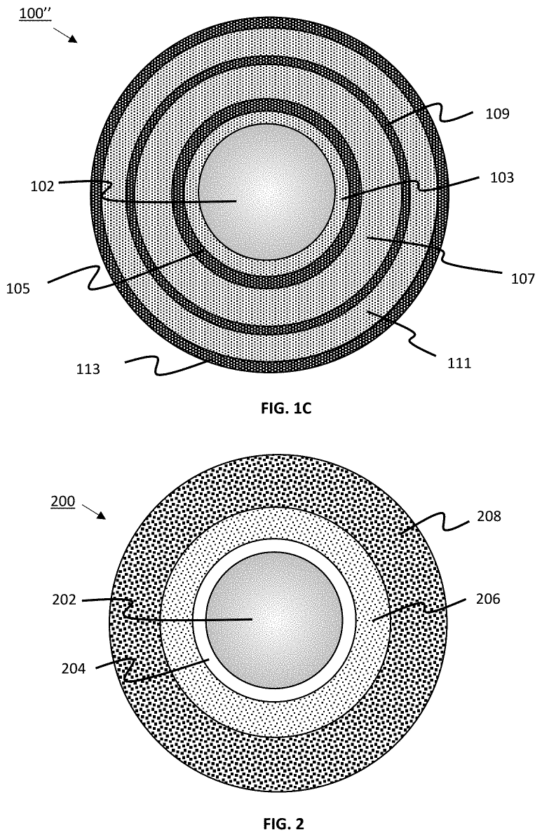

Over a base structure similar to that of Example 4A the following shell layers were added:
Si(1)/ZnSeS(1)/Si(1)
   FIG. 3 shows long-term stability data of the example nanocrystals which were placed in a silicone-based film along with conventional rare-earth-based phosphors. Since the rare-earth phosphors are stable in time, it is straightforward to extract the nanocrystal response from the overall phosphor spectra. The film was placed in open glass vials and excited by a blue 450 nm laser diode. The measured excitation power density was 18 W/cm². The air temperature was 25° C., with 40% RH. The glass vials were not heat sunk; thus, the film temperature was above ambient due to Stokes loss and the quantum efficiency being <100% (the measured quantum efficiency of the nanocrystals was ˜75%). As can be seen from FIG. 3, the integrated nanocrystal response is stable at least up to ˜330 hrs. of continuous laser diode excitation.

### Example 9

Over a base structure similar to that of Example 4A the following shell layers were added (parenthetical corresponds to number of monolayers):
ZnSeS(2)/Si(1)/ZnSeS(1)/Si(1).

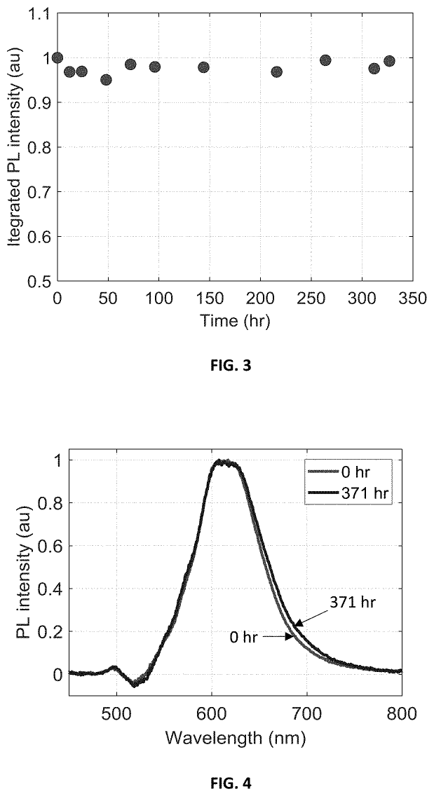

As with Example 8, the nanocrystals were placed in a silicone-based film along with conventional rare-earth-based phosphors. The excitation conditions were the same as for Example 8. As can be seen from FIG. 4, the extracted nanocrystal spectra were very stable in time, only having minor changes in spectral shape over 371 hours of continuous laser diode excitation.

Examples 8 and 9 show that nanocrystals of the present disclosure have very good QE and spectral stability, even in air. Such performance is very important for many practical applications such as solid-state lighting.

### Aspects of the Disclosure

In a first aspect, the disclosure a nanocrystal comprising a semiconductor core and a semiconductor shell at least partially surrounding the core, the shell comprising: a) a first discrete layer of a small-bandgap semiconductor having a bandgap in a range of about 0.2 eV to about 1.2 eV; and b) a region comprising a semiconductor having a bandgap of greater than about 1.2 eV.

In a second aspect, the disclosure provides the nanocrystal of first aspect, wherein the discrete layer comprises an indirect semiconductor.

In a third aspect, the disclosure provides a nanocrystal comprising a semiconductor core and a semiconductor shell at least partially surrounding the core, the shell comprising: a) a first discrete layer comprising a Group IV element and; b) a region comprising a semiconductor having a bandgap of greater than about 1.2 eV.

In a fourth aspect, the disclosure provides a nanocrystal of the first through third aspect, wherein the first discrete layer is an embedded layer.

In a fifth aspect, the disclosure provides a nanocrystal of the first through fourth aspect, wherein the first discrete layer is a capping layer.

In a sixth aspect, the disclosure provides a nanocrystal of the first through fifth aspect, wherein the first discrete layer includes at least one half of a monolayer of the Group IV element.

In a seventh aspect, the disclosure provides a nanocrystal of the first through sixth aspect, wherein the first discrete layer comprises Si or Ge.

In an eighth aspect, the disclosure provides a nanocrystal of the first through seventh aspect, wherein the shell comprises III-V, II-VI, I-IV-VII, or I-III-VI class semiconductor materials, or a combination thereof.

In a ninth aspect, the disclosure provides a nanocrystal of the seventh or eighth aspect, wherein the shell comprises ZnS, ZnSe, ZnSSe, CdS, CdSe, CdSeS, ZnMgSe, ZnMgS, ZnMgSSe, CdMgSe, CdMgS, CdMgSeS, CuCl, CuInS, or a combination thereof.

In a tenth aspect, the disclosure provides a nanocrystal of the first through ninth aspect, wherein the shell comprises a first region between the first discrete layer and the core, and a second region provided over the first discrete layer, the first and second regions being substantially free of Group IV elements, and wherein the first region has a shell composition that is the same as, or different from, the second region.

In an eleventh aspect, the disclosure provides a nanocrystal of the first through tenth aspect further comprising one or more additional discrete layers which are separated by regions that are substantially free of any Group IV elements, and wherein each such region has a shell composition that is the same as, or different from, another such region.

In a twelfth aspect, the disclosure provides a nanocrystal of the tenth through eleventh aspect, wherein the bandgap of the first discrete layer is smaller than that of the first region or the second region.

In a thirteenth aspect, the disclosure provides a nanocrystal of the eleventh aspect, wherein at least one of the one or more additional discrete layers includes the same Group IV element or set of Group IV elements as the first discrete layer.

In a fourteenth aspect, the disclosure provides a nanocrystal of the eleventh aspect, wherein at least one of the one or more additional discrete layers includes a different Group IV element or set of Group IV elements than the first discrete layer.

In a fifteenth aspect, the disclosure provides a nanocrystal of the first through fourteenth aspect, wherein the core includes one or more II-VI, III-V, IV-VI, I-III-VI or I-IV-VII class semiconductor materials.

In a sixteenth aspect, the disclosure provides a nanocrystal of the first through fifteenth aspect, wherein the shell comprises a magnesium-containing first zone and: a) a magnesium-free buffer zone provided between the core and the first zone; or b) a second zone distal from the core, the second zone having less magnesium than the first zone; or c) both a) and b).

In a seventeenth aspect, the disclosure provides a nanocrystal of the fifteenth aspect, wherein the first, second and buffer zones comprise greater than 50 atomic % II-VI class semiconductor materials.

In a eighteenth aspect, the disclosure provides a nanocrystal of the seventeenth or sixteenth aspect, wherein the first zone comprises ZnMgSe, ZnMgS, ZnMgSeS, CdMgSe, CdMgS, CdMgSeS or a combination thereof.

In a nineteenth aspect, the disclosure provides a nanocrystal of the sixteenth aspect through eighteenth aspect, wherein the first zone is 1 to 10 monolayers thick.

In a twentieth aspect, the disclosure provides a nanocrystal of the fifteenth aspect through eighteenth aspect, wherein the buffer zone comprises ZnSe, ZnS, ZnSeS, CdSe, CdS, CdSeS or a combination thereof.

In a twenty-first aspect, the disclosure provides a nanocrystal of the fifteenth aspect through twentieth aspect, wherein the buffer zone is 1 to 4 monolayers thick.

In a twenty-second aspect, the disclosure provides a nanocrystal of the fifteenth aspect through twenty-first aspect, wherein the first zone is thicker than the buffer zone.

In a twenty-third aspect, the disclosure provides a nanocrystal of the fifteenth aspect through twenty-second aspect, wherein the second zone is substantially free of magnesium.

In a twenty-fourth aspect, the disclosure provides a nanocrystal of the fifteenth aspect through twenty-third aspect, wherein the second zone comprises ZnSe, ZnS, ZnSeS, CdSe, CdS, CdSeS or a combination thereof.

In a twenty-fifth aspect, the disclosure provides a nanocrystal of the fifteenth aspect through twenty-fourth aspect, wherein the second zone is thicker than the first zone.

In a twenty-sixth aspect, the disclosure provides a nanocrystal of the fifteenth aspect through twenty-fifth aspect, wherein the second zone is 2 to 20 monolayers thick.

In a twenty-seventh aspect, the disclosure provides a nanocrystal of the fifteenth aspect through twenty-sixth aspect, wherein the first discrete layer is provided further from the core than the magnesium-containing first zone.

In a twenty-eighth aspect, the disclosure provides a nanocrystal of the first aspect through twenty-sixth aspect, wherein the core comprises a binary, ternary or quaternary semiconductor material.

In a twenty-ninth aspect, the disclosure provides a nanocrystal of the first aspect through twenty-sixth aspect, wherein the core comprises a ternary or quaternary semiconductor material having a non-homogeneous distribution of components.

In a thirtieth aspect, the disclosure provides the nanocrystal of twenty-eighth aspect or twenty-ninth aspect, wherein the core comprises Al, Ga or In, or a combination thereof.

In a thirty-first aspect, the disclosure provides the nanocrystal of twenty-eighth aspect through thirtieth aspect, wherein the core comprises P, N, As, or Sb, or a combination thereof.

In a thirty-second aspect, the disclosure provides the nanocrystal of first aspect through thirty-first aspect, wherein the shell fully surrounds the core.

In a thirty-third aspect, the disclosure provides a nanocrystal a nanocrystal comprising a semiconductor core and a semiconductor shell, wherein the semiconductor shell comprises: one or more II-VI class semiconductors that at least partially surrounds the core; magnesium; and at least one Group IV element, wherein the total atomic % of the Group IV element(s) is less than the total atomic % of all Group II elements of the shell.

In a thirty-fourth aspect, the disclosure provides the nanocrystal of aspect thirty-third aspect, wherein the shell includes ZnMgSe, ZnMgS, ZnMgSeS, CdMgSe, CdMgS, CdMgSeS or a combination thereof.

In a thirty-fifth aspect, the disclosure provides a nanocrystal of the thirty-third aspect or thirty-fourth aspect, wherein the Group IV element is Si, Ge or a combination thereof.

In a thirty-sixth aspect, the disclosure provides a nanocrystal of the thirty-third aspect or thirty-fifth aspect, wherein the core includes a ternary or quaternary semiconductor.

In a thirty-seventh aspect, the disclosure provides a nanocrystal of the thirty-sixth aspect, wherein the core has a non-homogeneous distribution.

In a thirty-eighth aspect, the disclosure provides a nanocrystal of the thirty-third aspect through thirty-seventh aspect, wherein the core includes a III-V class semiconductor.

In a thirty-ninth aspect, the disclosure provides a nanocrystal of the thirty-third aspect through thirty-eighth aspect, wherein the core comprises Al, Ga or In, or a combination thereof.

In a fortieth aspect, the disclosure provides a nanocrystal of the thirty-third aspect through thirty-ninth aspect, wherein the core comprises P, N, As, or Sb, or a combination thereof.

In a forty-first aspect, the disclosure provides a nanocrystal of the thirty-third aspect through fortieth aspect, wherein the core comprises InGaP.

In a forty-second aspect, the disclosure provides a nanocrystal of the thirty-third aspect through forty-first aspect, wherein the shell fully surrounds the core.

In a forty-third aspect, the disclosure provides a layer comprising a matrix material and nanocrystals according to any of the first through forty-second aspect.

In a forty-fourth aspect, the disclosure provides a layer according to the forty-third aspect, wherein the matrix comprises a silicone, a polymer or a glass.

In a forty-fifth aspect, the disclosure provides a solid-state lighting or display device comprising the layer of the forty-third or forty-fourth aspect.

1. A nanocrystal comprising a semiconductor core and a semiconductor shell at least partially surrounding the core, the shell comprising:
a) a first discrete layer of a small-bandgap semiconductor having a bandgap in a range of about 0.2 eV to about 1.2 eV; and
b) a region comprising a semiconductor having a bandgap of greater than about 1.2 eV.

2. The nanocrystal of claim 1, wherein the discrete layer comprises an indirect semiconductor.

3. A nanocrystal comprising a semiconductor core and a semiconductor shell at least partially surrounding the core, the shell comprising:
a) a first discrete layer comprising a Group IV element and;
b) a region comprising a semiconductor having a bandgap of greater than about 1.2 eV.

4. The nanocrystal of claim 3, wherein the first discrete layer includes at least one half of a monolayer of the Group IV element.

5. The nanocrystal of claim 3, wherein the first discrete layer comprises Si or Ge.

6. The nanocrystal of claim 3, wherein the shell comprises III-V, II-VI, I-IV-VII, or I-III-VI class semiconductor materials, or a combination thereof.

7. The nanocrystal of claim 3, wherein the shell comprises a first region between the first discrete layer and the core, and a second region provided over the first discrete layer, the first and second regions being substantially free of Group IV elements, and wherein the first region has a shell composition that is the same as, or different from, the second region.

8. The nanocrystal of claim 3, further comprising one or more additional discrete layers which are separated by regions that are substantially free of any Group IV elements, and wherein each such region has a shell composition that is the same as, or different from, another such region.

9. The nanocrystal of claim 7, wherein the bandgap of the first discrete layer is smaller than that of the first region or the second region.

10. The nanocrystal of claim 8, wherein at least one of the one or more additional discrete layers includes the same Group IV element or set of Group IV elements as the first discrete layer.

11. The nanocrystal of claim 8, wherein at least one of the one or more additional discrete layers includes a different Group IV element or set of Group IV elements than the first discrete layer.

12. The nanocrystal of any of claim 3, wherein the core includes one or more II-VI, III-V, IV-VI, I-III-VI or I-IV-VII class semiconductor materials.

13. The nanocrystal of claim 3, wherein the shell comprises a magnesium-containing first zone and:
a) a magnesium-free buffer zone provided between the core and the first zone; or
b) a second zone distal from the core, the second zone having less magnesium than the first zone; or
c) both a) and c).

14. The nanocrystal of claim 13, wherein the first, second and buffer zones comprise greater than 50 atomic % II-VI class semiconductor materials.

15. The nanocrystal of claim 13, wherein the second zone is substantially free of magnesium.

16. The nanocrystal of claim 13, wherein the first discrete layer is provided further from the core than the magnesium-containing first zone.

17. The nanocrystal of claim 13, wherein the core comprises:
(i) Al, Ga or In, or a combination thereof; and
(ii) P, N, As, or Sb, or a combination thereof.

18. A nanocrystal comprising a semiconductor core and a semiconductor shell, wherein the semiconductor shell comprises:
one or more II-VI class semiconductors that at least partially surrounds the core;
magnesium; and
at least one Group IV element, wherein the total atomic % of the Group IV element(s) is less than the total atomic % of all Group II elements of the shell.

19. The nanocrystal of claim 18, wherein the Group IV element is Si, Ge or a combination thereof.

20. The nanocrystal of claim 18 wherein the core includes a III-V class semiconductor.

21. The nanocrystal of any of 18 wherein the core comprises:
(i) Al, Ga In, or a combination thereof; and.
(ii) P, N, As, or Sb, or a combination thereof.
